(19) United States
(12) Patent Application Publication
(10) Pub. No.: US 2020/0227879 A1
(43) Pub. Date: Jul. 16, 2020

(54) A LASER GUIDE DEVICE

(71) Applicant: Kyle Berryman, Carrara, QLD (AU)

(72) Inventor: Kyle Berryman, Carrara, QLD (AU)

(21) Appl. No.: 15/755,663

(22) PCT Filed: Sep. 5, 2016
(86) PCT No.: PCT/AU2016/050837

§ 371 Date: Feb. 27, 2018

(30) Foreign Application Priority Data
Sep. 4, 2015 (AU) 2015903619

(51) Int. Cl. H01S 3/02; G01B 11/27

(52) U.S. Cl. CPC H01S 3/02; G01B 11/27

(57) ABSTRACT

A laser guide device includes a laser for emitting a laser beam along a guide axis. A mounting system is operatively arranged with respect to the laser and is configured for mounting the laser centrally within or adjacent a cylindrical mouth opening of an object. The mounting system includes at least one grip arrangement for mounting the laser guide device on a rim defining the cylindrical mouth opening. The, or each, grip arrangement defines at least one grip formation for bearing against one of a radially outer and a radially inner surface at the mouth opening.

### FIELD

Various exemplary embodiments of a laser guide device are described herein. More particularly, but not exclusively, various exemplary embodiments of a laser guide device having a mounting system configured to attach to a pipe or fitting are described herein.

### SUMMARY

Various exemplary embodiments of a laser guide device comprise

a laser for emitting a laser beam along a guide axis; and

a mounting system operatively arranged with respect to the laser and configured for mounting the laser centrally within or adjacent a cylindrical mouth opening of an object, the mounting system including at least one grip arrangement for mounting the laser guide device on a rim defining the cylindrical mouth opening, the, or each, grip arrangement defining at least one grip formation for peering against one of a radially outer and a radially inner surface at the mouth opening.

The, or each, grip formation may define a gap in which the rim can be received.

The mounting system may include a carrier for carrying the laser. The, or each, grip arrangement may be arranged on the carrier and may include at least one set of two, facing, internal gap walls that are spaced apart to define the gap. The internal gap walls may have concentric arcuate profiles relative to the guide axis.

The mounting system may include at least two grip arrangements with the internal walls of the grip formations being circumferentially aligned so that the gaps occupy a circular or annular path about the guide axis.

Each grip arrangement may include at least two grip formations that are radially spaced relative to the guide axis.

Each grip arrangement may be detachable from the carrier to be replaced with grip arrangements having different configurations to suit differently sized pipes or fittings.

The carrier may include a hub that houses the laser. The grip arrangements may include arms that extend radially from the hub, axially with respect to the guide axis. The grip formations may be spaced along the arms. The grip formations may be tabs or lugs.

Each grip arrangement may include a base with each arm extending from a respective base. The hub and the bases may define complementary releasable engaging formations so that the bases can be removably mounted on the hub for replacement.

The hub may have a hub wall that defines recesses, the recesses and the bases being configured so that the bases can slide into and out of the recesses. A retaining mechanism may be arranged on the hub wall to retain, in a releasable manner, the bases in the respective recesses.

Various exemplary embodiments of an adaptor for the laser guide device include

a body that defines a formation for receiving part of the laser guide device described above to fit the adaptor to the laser guide device; and

at least one mounting arrangement positioned on the body for mounting the body on the rim, the, or each, mounting arrangement extending radially beyond the, or each, grip arrangement with reference to the guide axis.

The mounting arrangement may include arms that extend radially from the body, with reference to the guide axis, and mounting formations arranged on the arms for mounting on the rim so that the body is supported by the arms. The mounting formations may be tabs or lugs that extend from the arms.

The tabs or lugs may be positioned on the arms so that they can bear against an internal surface of the pipe or fitting. The tabs or lugs may be spaced inwardly from respective, associated ends of the arms so that the rim can be brought into abutment with end portions of the arms to facilitate location of the adaptor.

Various exemplary embodiments of a kit comprise the laser guide device and the adaptor.

Various exemplary embodiments of a laser guide device comprise a mounting system that includes at least one grip arrangement for mounting the laser guide device on a rim that defines a cylindrical mouth opening of an object, the mounting system being configured for mounting a laser centrally within or adjacent the cylindrical mouth opening, the, or each, grip arrangement defining at least one grip formation for bearing against one of an outer and an inner wall defining the mouth opening.

Various exemplary embodiments of a method of providing a guide for an object, the method comprising the steps of

positioning a laser guide device within or adjacent a cylindrical mouth opening of the object, the laser guide device including a laser for emitting a laser beam along a guide axis and a mounting system operatively arranged with respect to the laser and configured for mounting the laser centrally within or adjacent the cylindrical mouth opening and including at least one grip arrangement so that the laser guide device is mounted on a rim defining the cylindrical mouth opening, the, or each, grip arrangement defining at least one grip formation for bearing against one of a radially outer and a radially inner surface defining the mouth opening; and

operating the laser to emit the laser beam along the guide axis.

### BRIEF DESCRIPTION OF THE DRAWINGS

FIG. 1 shows an exploded view of an exemplary embodiment of a laser guide device.

FIG. 2 shows a three-dimensional view, from the back, of the laser guide device of FIG. 1.

FIG. 3 shows a three-dimensional view, from the front, of the laser guide device of FIG. 1.

FIG. 4 shows a three dimensional view, from the front, of the laser guide device of FIG. 1, with a lens and switch disassembled from a hub of the guide device.

FIG. 5 shows a three dimensional view, from the back, of the laser guide device of FIG. 1, with a laser and a battery disassembled from the hub of the guide device.

FIG. 6 shows a three dimensional view, from the back, of the laser guide device of FIG. 1, with a back cover of the laser guide device removed.

FIG. 7 shows a three dimensional view, from the back, of the laser guide device of FIG. 1, with the back cover removed.

FIG. 8 shows another three dimensional view, from the back, of the laser guide device of FIG. 1, with the back cover removed.

FIG. 9 shows a three dimensional view of the laser guide device of FIG. 1 adjacent a fitting.

FIG. 10 shows a three dimensional view of the laser guide device of FIG. 1 mounted to the fitting of FIG. 9.

FIG. 11 shows a three dimensional view of the laser guide device of FIG. 1 mounted to the fitting of FIG. 9 and projecting a laser beam dot onto a surface.

FIG. 12 shows a three dimensional view, from the back, of an exemplary embodiment of an adaptor for mounting the laser guide device of FIG. 1 to pipes or fittings that are larger than the pipes or fittings suited for the laser guide device of FIG. 1.

FIG. 13 shows a three dimensional view, from the front, of the adaptor of FIG. 12.

FIG. 14 shows a three dimensional view of the adaptor of FIG. 12 and the laser guide device of FIG. 1 spaced from the adaptor to be fitted to the adaptor.

FIG. 15 shows a three dimensional view, from the back, of the adaptor of FIG. 12 fitted to the laser guide device.

FIG. 16 shows a three dimensional view, from the front, of the adaptor of FIG. 12 fitted to the laser guide device.

FIG. 17 shows a three dimensional view of the adaptor of FIG. 12, including the laser guide device, mounted to a plumbing fitting.

FIG. 18 shows a three dimensional view, from the front, of another embodiment of an adaptor, having longer arms than the adaptor of FIG. 12.

FIG. 19 shows a three dimensional view, from the front, of yet another embodiment of an adaptor, having longer arms than the adaptor of FIG. 18.

FIG. 20 shows an exploded view of an exemplary embodiment of a laser guide device.

FIG. 21 shows a side view of the laser guide device of FIG. 20.

FIG. 22 shows a sectioned view of the laser guide device taken through A-A in FIG. 21.

### DESCRIPTION OF EXEMPLARY EMBODIMENTS

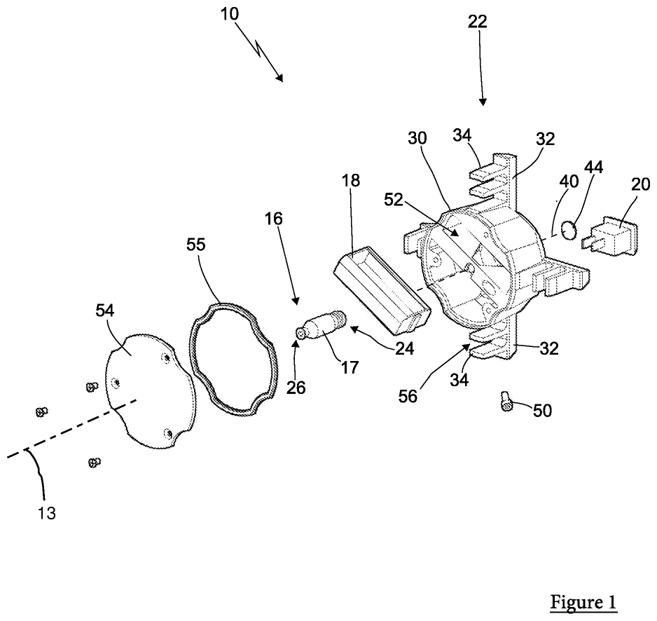

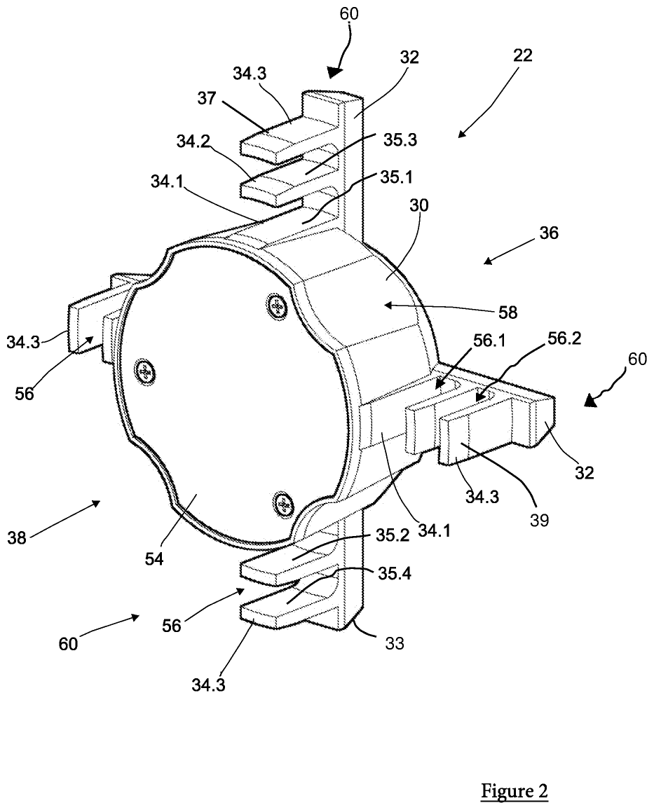

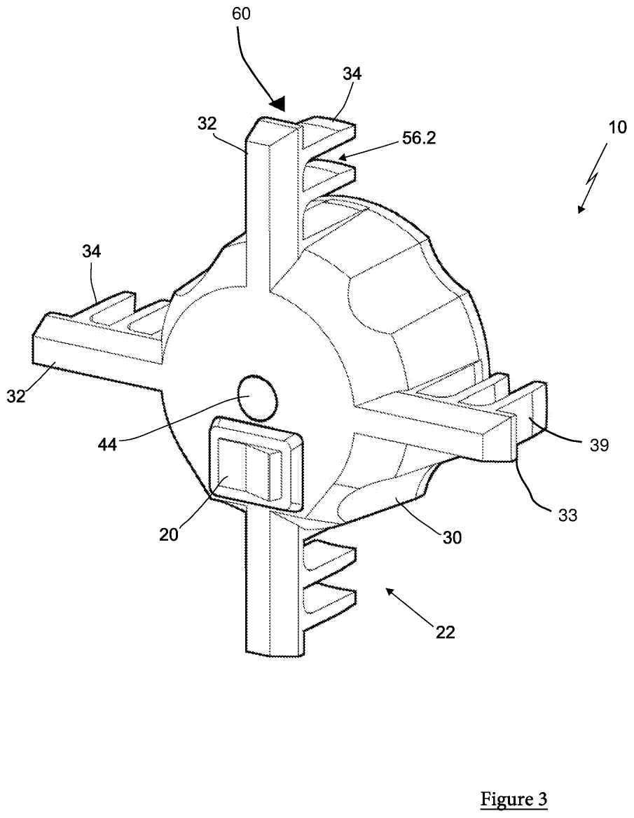

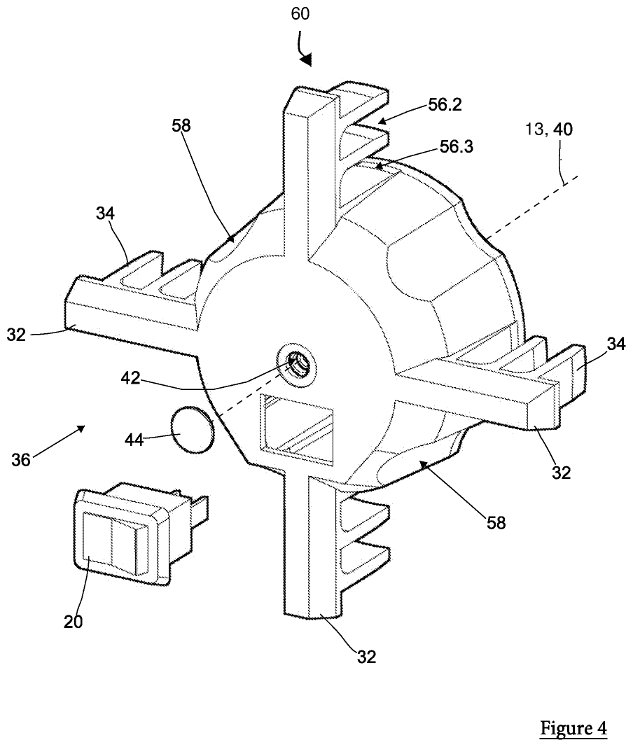

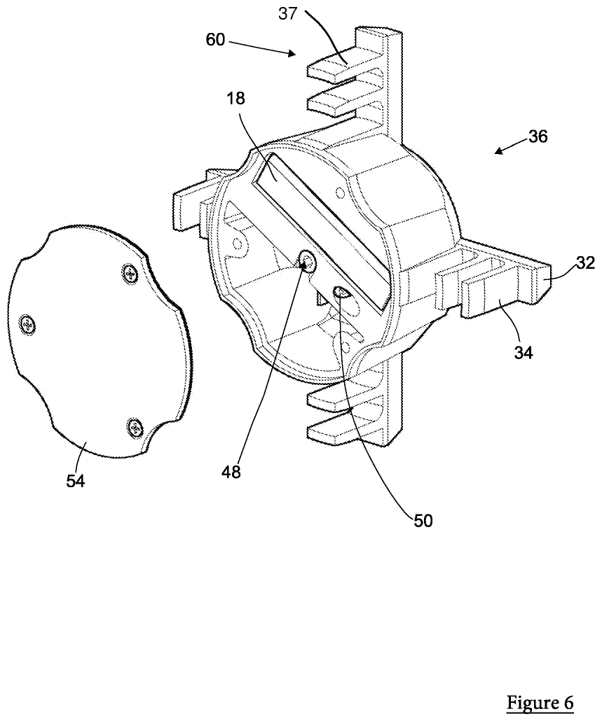

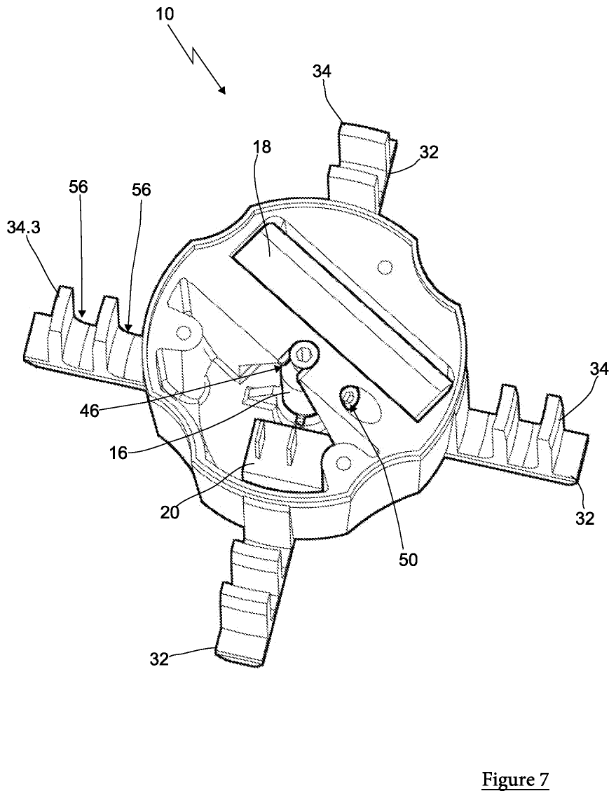

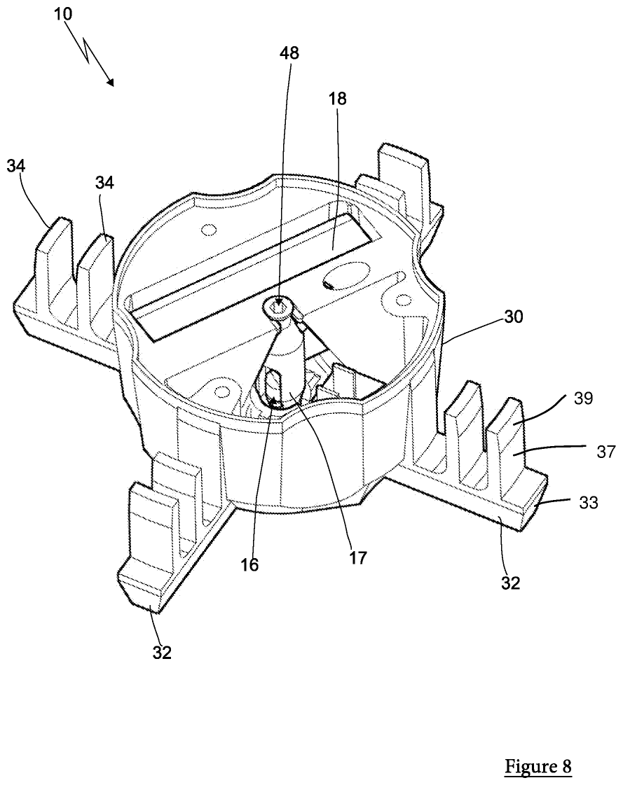

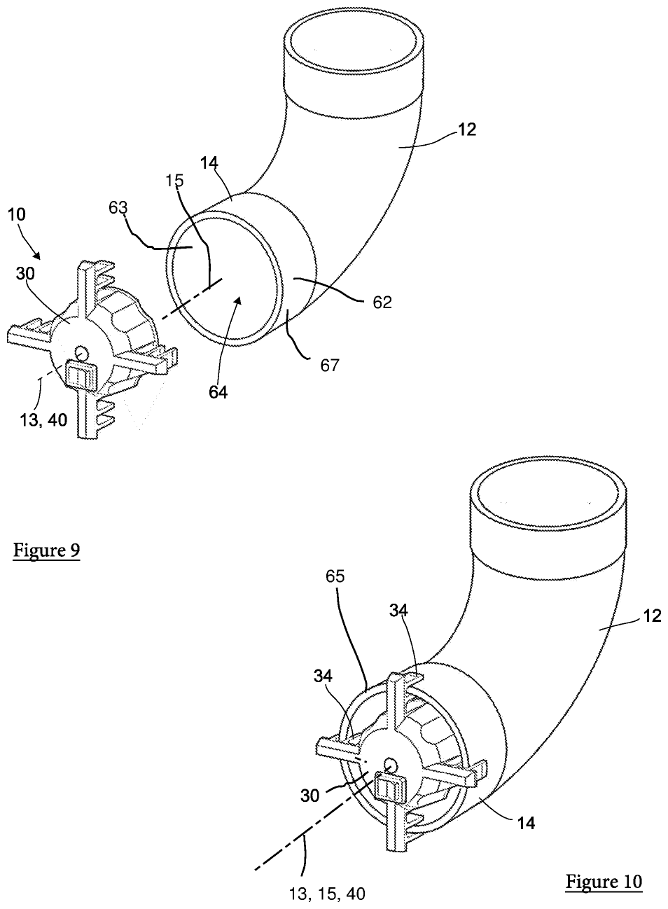

Referring to FIGS. 1 to 11, reference number 10 generally indicates an exemplary embodiment of a laser guide device. The laser guide device 10 is used to emit a laser beam that projects from a centre of a cylindrical mouth opening 64 (FIG. 9) of an object along a guide axis 13. In use, the guide axis 13 is substantially collinear with a central axis 15 (FIG. 9) of the mouth opening. For example, the laser guide device 10 may be mounted to on a rim 65 at an end of a plumbing fitting 12 (FIGS. 9 and 10) or a pipe during installation of plumbing.

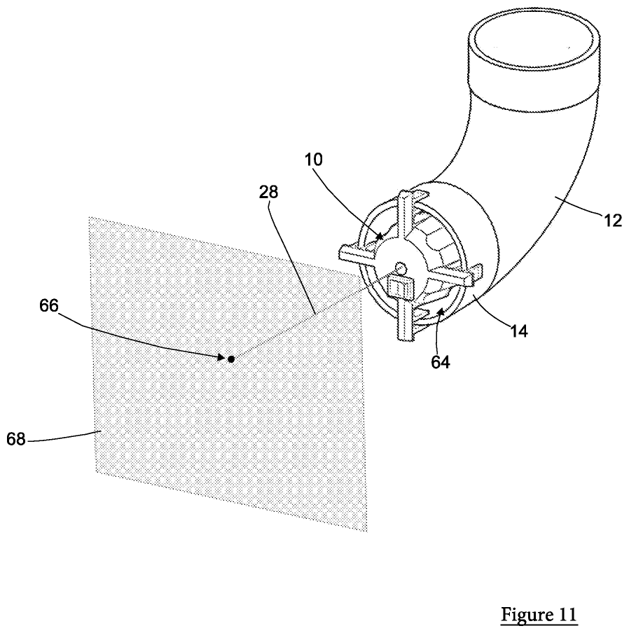

The laser guide device 10 includes a laser 16 for projecting a laser beam 28 (FIG. 11) along the guide axis 13, an energy source in the form of a battery 18 for energising the laser 16, a switch 20, and a mounting system 22 for mounting the laser 16 to the fitting 12 or pipe.

The laser 16 includes a housing 17 and a laser module held within the housing. The laser module may be any suitable off-the-shelf dot laser module. In one embodiment, the laser module is a 3 volt, direct current, copper head tube module producing a laser with a wavelength of 650 nm (red). The example laser module has an output power of 5 mW and produces a laser with a diameter of approximately 6 mm. Other forms of laser can also be suitable, depending on technical requirements, availability and cost. The housing 17 has a front end 24 and a rear end 26.

The laser 16 is connected to the battery 18 via the switch 20. The switch 20 has an “on” position wherein the laser 16 is energised by the battery 18 to emit the laser beam 28. The switch 20 has an “off” position wherein the laser 16 is electrically isolated from the battery 18. Reference to the battery 18 in the drawings may be reference to a battery housing for receiving a replaceable or rechargeable battery or a bank of replaceable or rechargeable batteries.

The mounting system 22 includes carrier for carrying the laser 16. The carrier includes a hub 30. The mounting system includes gripping arrangements that are arranged about the hub 30. The gripping arrangements include arms 32 radiating from the hub 30, axially with respect to the guide axis 13, and grip formations in the form of two lugs or tabs 34 spaced along the arms 32 and extending generally backwardly and parallel to the guide axis 13. It is envisaged that one or more lugs or tabs 34 may be spaced along the arms 32.

The hub 30 has a front 36 and a back 38. The hub 30 is between 20 mm and 60 mm thick or deep measured between the front 36 and the back 38 of the hub, for example 35 mm thick. Other thicknesses or depths are envisaged, depending on the application, for example, depending on the size of the pipe or fitting.

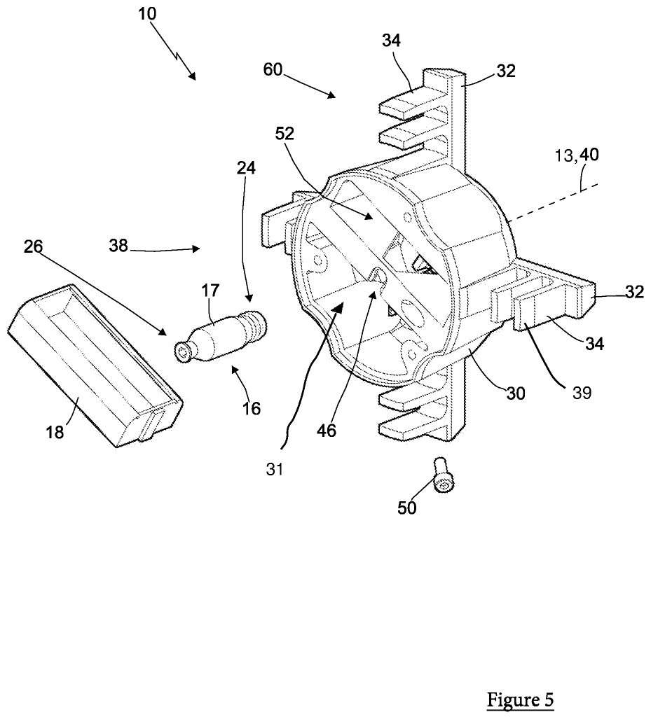

The hub 30 is generally cylindrical. The hub 30 has a rotational axis 40 that is collinear with the guide axis 13. The hub 30 has a socket 31 (FIG. 5) which communicates with a central passage 42 at the front 36, through which the laser beam 28 is emitted. The passage 42 is covered by a lens 44. The front end 24 of the laser 16 seats in the passage 42. The hub 30 has a clip 46 (FIG. 5) at the back 38 for holding the rear end 26 of the laser 16. The rear end 26 of the laser housing 17 is received in the clip 46 of the hub 30. The laser housing 17 has a key socket 48 at the rear for rotating the laser housing 17 while it is held in the hub 30. The hub 30 includes an adjustment screw 50 which can be used for slight corrections of the orientation of the laser 16 within the hub. The adjustment screw 50 bears against the rear end region of the laser housing 17. The orientation of the laser 16 relative to the rotational axis 40 of the hub 30 can be adjusted by rotating the laser 16 using the key socket 48 and making necessary lateral adjustments using the adjustment screw 50.

The back 38 of the hub 30 is closed off by a removable back plate 54. The device 10 includes a seal 55 between a body of the hub 30 and the back plate 54. The seal 55 is in the form of a gasket which prevents ingress of moisture into the hub 30. The back plate 54 is screwed onto the back of the hub 30.

The hub 30 has a cavity 52 for receiving the battery 18. The cavity 52 is accessible from the back 38 of the hub 30 by removing the back plate 54.

The hub 30 has finger grips 58 in the form of longitudinal fluting on the outside of the hub 30. The laser guide device 10 can be gripped by the finger grips 58 to extract the device 10 from a mouth opening.

The mounting system 22 has three or more gripping arrangements 60 that are equally and circumferentially spaced about the hub 30. In this particular embodiment, there are four gripping arrangements 60. Each gripping arrangement 60 includes an arm 32 extending radially from the hub 30. Thus, each arm 32 is angularly offset by 90° with respect to adjacent arms 32.

The arms 32 radiate outwardly from a region at the front 36 of the hub 30. The arms 32 extend in a direction generally radially with respect to the rotational axis 40 of the hub 30. Thus, the arms 32 extend radially with respect to the guide axis 13.

Each arm 32 has a set of three tabs 34.1, 34.2 and 34.3 that extend backwardly from the arms 32 and generally parallel to the guide path. The tabs 34.1, which are closest to the hub 30, are continuous with the outer surface of the hub 30. In other words, they can form part of the outer surface of the hub 30. The other two tabs 34.2 and 34.3 of a set of tabs are spaced from the hub 30, in line with the tab 34.1. The tabs 34 are chamfered radially inwardly towards their free ends to facilitate location of the tabs 34 into bearing engagement with an internal surface of a pipe or fitting.

The tabs 34.1, 34.2 and 34.3 are spaced on respective common and concentric circumferential lines with respect to the rotational axis 40.

The tabs 34.1 and 34.2 of each gripping arrangement 60 define facing, internal walls 35.1 and 35.2 that define a gap 56.1. The internal walls 35.1 and 35.2 have arcuate, concentric profiles with reference to the rotational axis 40. Thus, the gaps 56.1 lie along an annular path with reference to the rotational axis 40. Likewise, the tabs 34.2 and 34.3 define internal walls 35.3 and 35.4 that define a gap 56.2. The internal walls have arcuate, concentric profiles with reference to the rotational axis 40. Thus, the gaps 56.2 also lie along an annular path with reference to the rotational axis 40.

The gaps 56 may be between 8 mm and 11 mm wide, for example about 10 mm wide. It is to be appreciated that this dimension can vary depending on the required application. The tabs 34 are spaced along their respective arms 32 so that respective gaps 56 of each gripping arrangement 60 overlap.

The internal walls 35.1 are generally coincident with a line that has a diameter corresponding to an inside diameter of a standard or selected fitting or pipe. The fitting or pipe may be a plumbing fitting or pipe. The gaps 56.1 can correspond with, or accommodate, a wall thickness of that plumbing fitting or pipe. The internal walls 35.3 are generally coincident with a line that has a diameter corresponding to an inside diameter of another standard or selected fitting or pipe. Again, the fitting or pipe may be a plumbing fitting or pipe. The gaps 56.2 can correspond with, or accommodate, a wall thickness of that plumbing fitting or pipe.

Each of the tabs 34.3 has an external wall 37. The external walls 37 are generally coincident with a line that has a diameter corresponding to an inside diameter of a standard or selected fitting or pipe. The fitting or pipe may be a plumbing fitting or pipe.

From the above, it will be appreciated that the gripping arrangements 60 can engage three differently sized pipes by receiving rims of the respective pipes in either of the gaps 56.1 or 56.2 or over the walls 37. The tabs 34 are positioned and dimensioned so that the walls 35.1, 35.3 and 37 frictionally engage the respective inner surfaces of the fitting or pipe. A chamfer 39 of the tabs 34 facilitate location of the walls 35.1, 35.3 and 37 into frictional engagement with the inner services so that the laser guide device 10 can be retained in position. For example, the tabs 34 can be positioned and dimensioned so that the frictional engagement is through an interference fit within the fitting or pipe.

In one embodiment, the outside diameters of the walls 35.1, 35.3 and 37, measured where the tabs 34 meet the arms 32, can be approximately 70 mm, 90 mm and 110 mm, respectively, for example 69 mm, 90.6 mm and 110 mm.

In other embodiments, there may be a single gripping arrangement that includes concentric circular, or part-circular rings that define, respectively, internal walls that have diameters that correspond with diameters of the pipes or fittings referred to above. Similarly, the rings can be spaced to define gaps to receive rims of the pipes or fittings referred to above. Furthermore, it is envisaged that the tabs 34 can have different shapes and configurations with the requirement that they are capable of engaging the internal surface of the pipe or fitting.

In other embodiments, the tabs 34 are positioned and dimensioned so that the walls 35.2 and 35.4 can engage an external surface of the pipes or fittings, in the manner described above with reference to the walls 35.1, 35.3 and 37.

As described above, the tabs 34.1 can be continuous with the hub 30. It follows that the grip arrangements can also include part or parts of the hub 30 itself.

It is envisaged that any number of grip formations can be provided to suit a range of pipes or fittings. Thus, the laser guide device 10 may have longer or shorter arms 32 with more or less tabs 34 as required for pipes and fittings of different inside diameters.

With reference to FIGS. 9 and 10, the laser guide device 10 is mounted to the fitting 12. The fitting 12 is a 90° elbow, but may be any fitting such as a T- fitting, a Y-fitting, a coupling or an adaptor. The fitting 12 has a cylindrical collar 14 defining the mouth opening 64 and the rim 65. The collar 62 has a thickness and an internal diameter.

The laser guide device 10 is aligned with the collar 14, as shown in FIG. 9 and then engaged with the rim 65. The guide axis 13 is aligned with the central axis 15 of the collar 14. The laser guide 10 is then displaced in the axial direction toward the collar 14 so as to mount the laser guide 10 on the collar 14 as described below. Thus, the laser guide device 10 is positioned within or adjacent the opening 64 of the collar 14.

The tabs 34 of one of the grip arrangements 60 engage a radially inner surface 63 at the mouth opening 64 to mount the laser guide device 10 to the collar 14 by way of an interference fit or a friction fit. In other embodiments, the tabs 34 can engage an outer surface 67 of the collar 14. Thus, the grip arrangements 60 plug into the mouth opening 64 of the collar 14. More specifically, the internal wall 35.3 has a diameter that substantially corresponds with the inner diameter of the collar 14 and so grips the inside of the collar 14. The gaps 56.2 are wide enough so that the rim 65 is received in the gaps 56.2. The same could apply to the other walls 35, 37.

The tabs 34.3 extend from their associated arms 32 at a certain distance from an end of that arm 32. Thus, there is provided an end portion 33 that projects outwardly from the tab 34.3 so that the rim 65 can bear against the end portion 33 to facilitate proper location of the laser guide device 10. For example, the end portion 33 can prevent over-insertion of the device 10 into the pipe or fitting.

Referring to FIG. 11, the switch 20 is in the “on” position so that the laser beam 28 is emitted from the front of the hub 30. The laser beam 28 projects from the centre of the mouth opening, where the laser 16 is supported, and along the guide axis 13. The laser beam 28 is substantially collinear with the central axis 15 of the collar 14. The laser beam 28 is thus an extension of the central axis 15 of the collar 14. That is to say that the laser beam 28 effectively projects from the centre of the collar 14. This is useful when installing plumbing as the laser beam 28 establishes a dot 66 where the centre of the collar 14 would be if the collar 14 was extended. FIG. 11 shows a wall 68 opposite the fitting 12. The dot 66 on the wall 68 is a guide which indicates the centre point for drilling a hole in the wall 68 to accommodate a pipe which runs through the wall 68 to the fitting 12 to be received in the collar 14. Although a dot 66 is shown, the laser 16 may project other patterns such as cross-hairs, a circle or concentric circles.

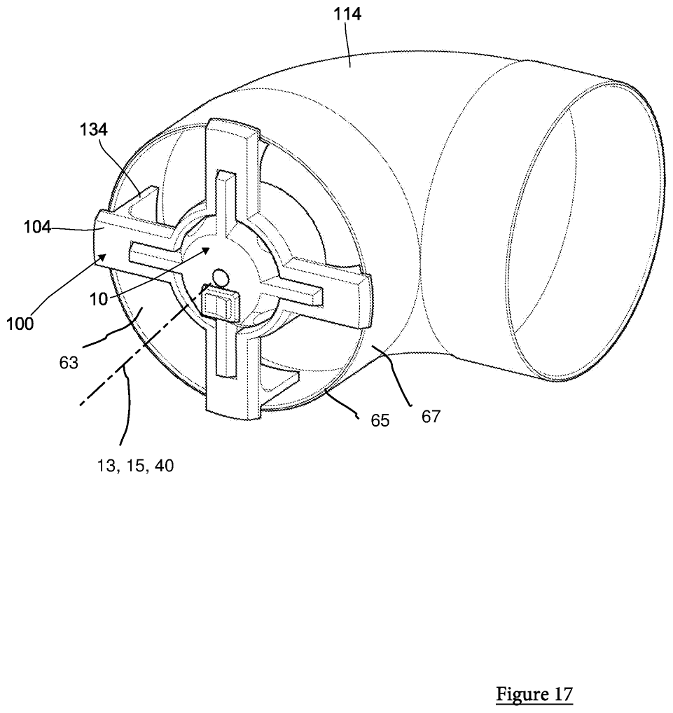

Reference may be had to the pipe alignment tools of U.S. Pat. No. 7,467,474 to Statham. One of the alignment tools of the Statham patent has cylindrical sections of different sizes stepped along the axial length of the tool for differently sized internal pipe diameters. The axial length of the tool, due to the axially spaced sections, can make the tool inconvenient to store and carry and impractical to use with fittings. It may be difficult to use the Statham tool with the 90° bend fittings shown in FIG. 9 or 17 of this application. The reason is that the back of the Statham tool may hit the inside of the bend before the tool can be seated in the collar. Other embodiments of a pipe alignment tool of the Statham patent have bodies that expand to engage the inside of a pipe. The mechanisms to expand the bodies appear relatively complex in that they have moving parts to expand legs of the alignment device and may be expensive to manufacture and prone to breaking.

The laser guide device 10 of the present application is mechanically simple and easy to mount to a fitting or pipe. The laser guide device 10 only stands proud of the collar 14 by about the thickness of the arms 30, but does not extend into the fitting or pipe by a distance more than the collar 14. The laser guide device 10 may thus be mounted to a fitting and the fitting can still be manoeuvred in tight spaces. The mounting system 12 of the laser guide device 10 is mechanically simple with no moving parts.

The laser guide device 10 does not plug the whole of the mouth opening 64. Spaces between the legs 32 allow liquid in the fitting to flow past the laser guide device 10 if necessary.

The arms 32 of the laser guide 10 may effectively be extended by an adaptor having mounts such as arms that are longer than those of the laser guide 10. The laser guide device 10 may then be mounted to pipes or fittings with larger inner diameters.

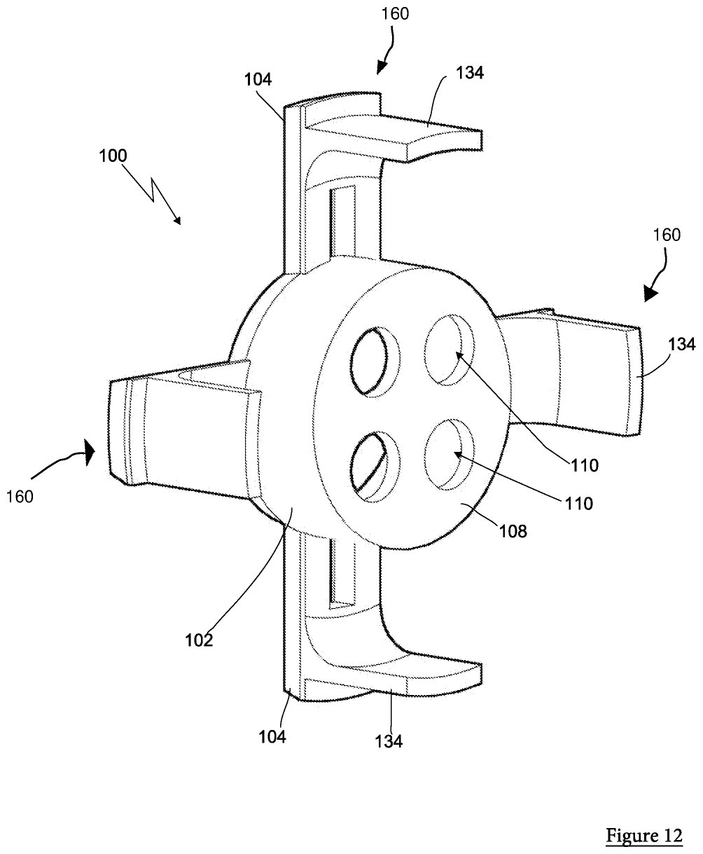

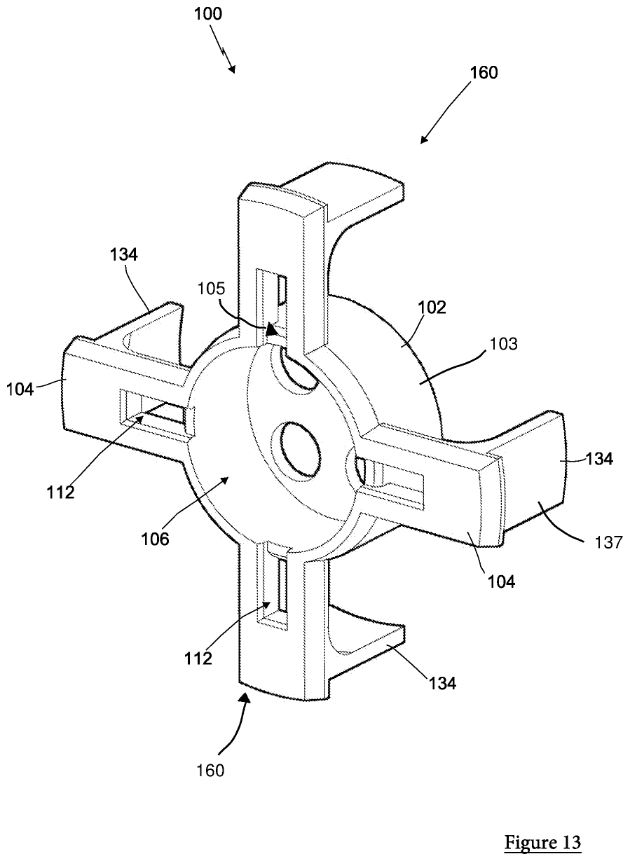

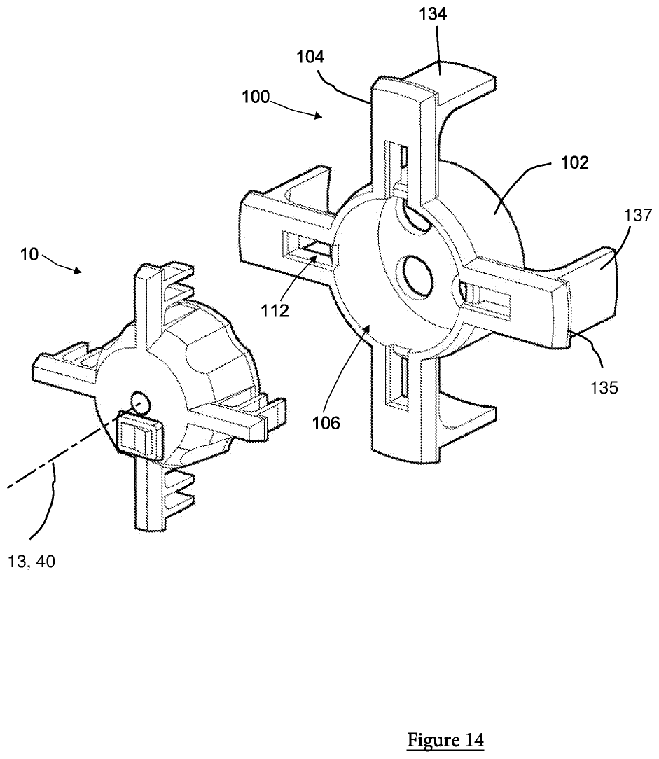

FIGS. 12 to 14 show an adaptor 100. The adaptor 100 has a body 102 and a mounting arrangement for mounting the body 102 on the rim 65. The mounting arrangement extends radially beyond the grip arrangements 60. Thus, the adaptor 100 can be fitted to pipes or fittings that are larger than those to which the device 10 can be fitted. For example, the mounting arrangement effectively extends the length of the arms 32 and has mounting arrangements 160 with a larger outer radius, with reference to the guide axis 13, than the grip arrangements 60 of the laser guide device 10 so that they can extend beyond the grip arrangements 60.

The adaptor 100 includes a cylindrical body 102 and arms 104 radiating from the body 102. The body 102 has a socket or cavity 106 in which the hub 30 of the laser guide device 10 is received. The back of the cavity 106 is closed off by a back plate 108. The back plate 108 has a number of holes 110 for pushing the hub 30 out of the cavity 106 to separate the laser guide device 10 from the adaptor 100.

The arms 104 support a set of circumferential tabs 134 of the mounting arrangements 160, which function in the same manner as the tabs 34 of the laser guide device 10. Thus, the tabs 134 extend forwardly with respect to the arms 104. The tabs 134 have an outer wall 137 that is configured to engage the inner surface of the pipe or fitting in the same manner as the wall 37 engages the inner surface of a smaller pipe or fitting. The outer wall 137 can have a radius, with reference to the guide axis 13, that is selected to suit the larger pipe or fitting. For example, the radius can be between approximately 70 mm or 80 mm. However, it is envisaged that this dimension can vary depending on the application. Although each arm 104 supports only one tab 134, another embodiment of the adaptor 100 may have a number of tabs 134 spaced along each arm 104, in the same or similar manner as the tabs 34 of the laser guide device 10.

The arms 104 have windows 112 through which the tabs 34 of the laser guide device 10 project. The windows 112 are configured so that the tabs 34 can be retained within the windows 112 in order to mount the device 10 on the adaptor 100. For example, the body 102 has a radius that corresponds with a radial position of the walls 35.1. The windows 112 can be dimensioned so that the arms 32 are received in respective windows 112 with the walls 35.1 frictionally engaging the body 102.

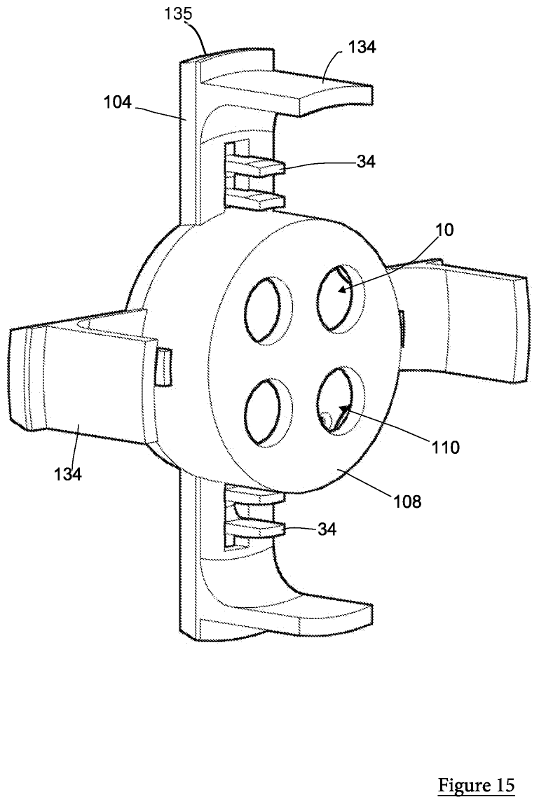

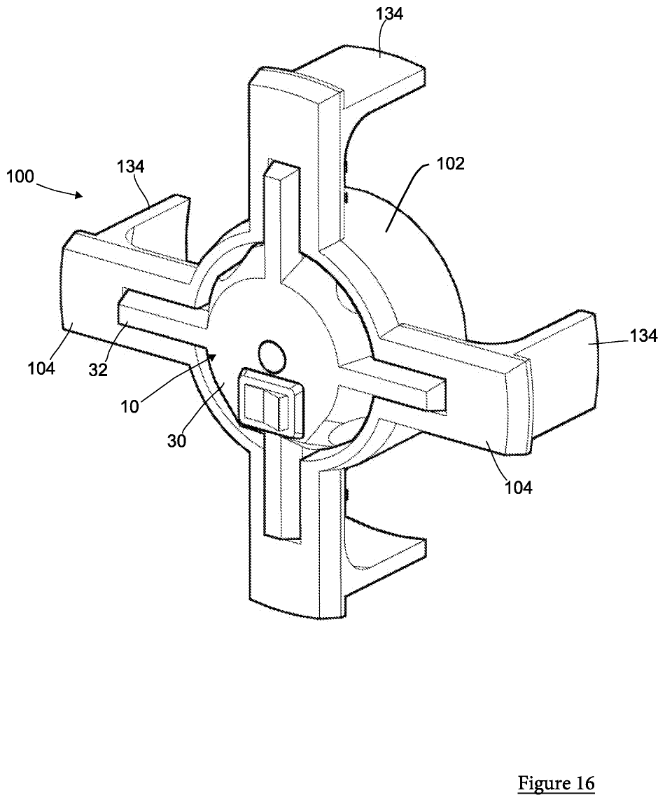

The body 102 includes a cylindrical wall 103. The arms 104 extend from a rear end of the wall 103. The rear end of the wall 103 defines a series of circumferentially spaced recesses 105 that are aligned with respective windows 112. The recesses 105 are dimensioned so that the arms 32 can be at least partially received within the recesses 105 to accommodate engagement of the walls 35.1 with the body 102, as shown in FIGS. 15 and 16.

Each of the tabs 134 extends from its associated arm 104 at a certain distance from an end of that arm 104. Thus, there is provided an end portion 135 that projects outwardly from the tab 134 so that the rim 65 can bear against the end portion 135 to facilitate proper location of the adaptor 100. For example, the end portion 135 can prevent over-insertion of the adaptor 100 into the pipe or fitting.

Referring to FIGS. 15 and 16, the adaptor 100 is shown fitted to the laser guide device 10. FIG. 17 shows the combined adaptor 100 and laser guide device 10 mounted to a fitting 114 in the form of a 90° elbow.

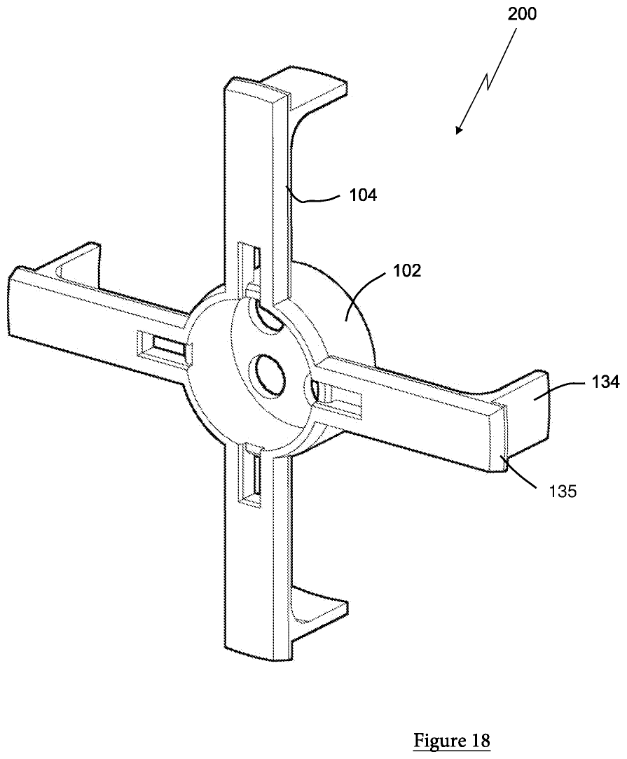

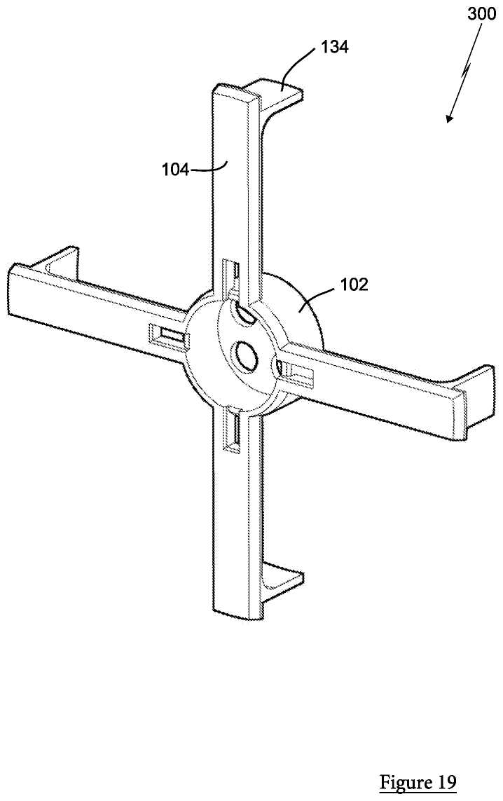

Referring to FIGS. 18 and 19, adaptors 200 and 300 with different length arms to the arms 104 of adaptor 100 are shown. The adaptors 200 and 300 are the same as the adaptor 100, the only difference being the length of the arms 104 and the radial positions of the tabs 134. For example, the outer wall 137 of the adaptor 200 can be radially positioned between about 100 mm and 120 mm from the guide axis 13. The outer wall 137 of the adaptor 300 can be radially positioned between about 140 mm and 160 mm from the guide axis 13.

The laser guide device 10 may be sold with the adaptors 100, 200, 300 as a kit. The adaptors 100, 200, 300 increase the number of fitting sizes to which the laser guide device 10 can be mounted, specifically relatively large fitting or pipe sizes.

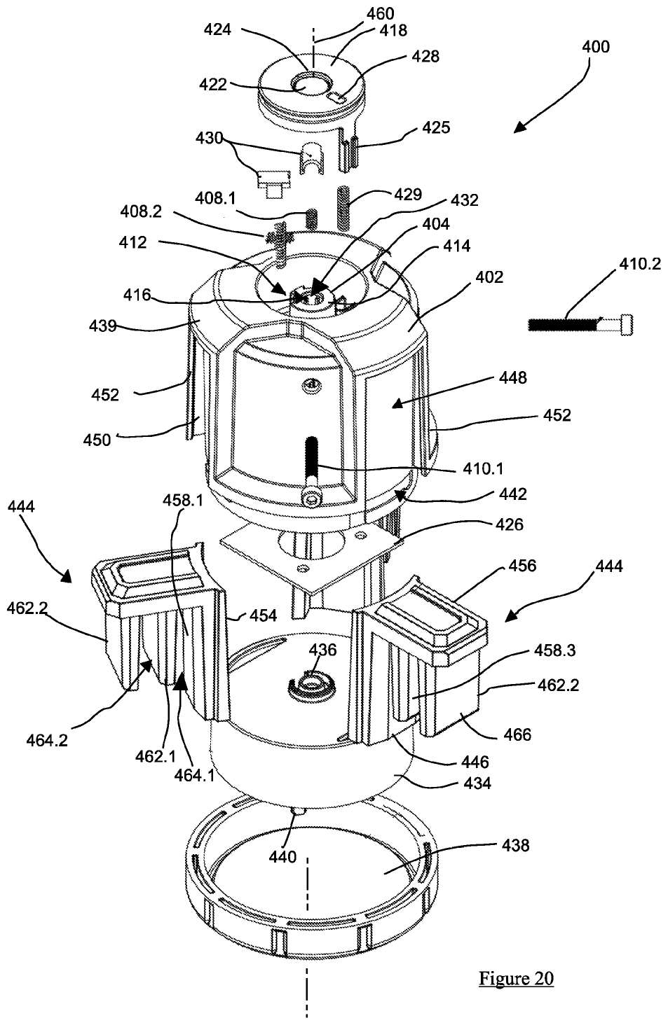

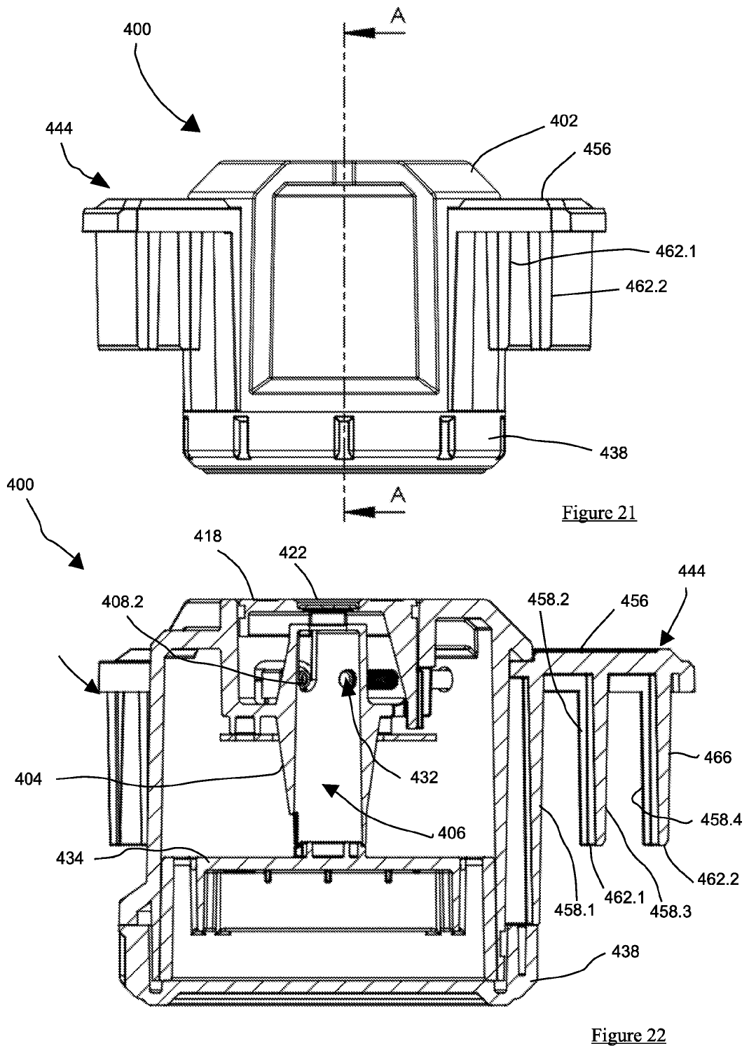

In FIGS. 20 to 22, reference numeral 400 generally indicates an embodiment of a laser guide device.

The laser guide device 400 includes the carrier, also in the form of a hub 402. The hub 402 has an internal substructure 404 that defines a socket 406 in which the laser 16 is housed.

The laser 16 is biased in a predetermined orientation with laser calibration springs 408.1 and 408.2 that are located in the socket 406 to bear against the laser 16. The calibration springs 408.1 and 408.2 are held in position by spring holders 430. Each of the springs 408 extend through slots 432 to bear against the laser 16. The springs 408 are oriented orthogonally with respect to each other and generally orthogonally with respect to the laser beam 28. Two adjustment screws 410.1 and 410.2 are threaded into the substructure 404 and are accessible from outside the hub 402. The adjustment screws 410 are oriented at right angles to each other and in alignment with respective springs 408.1 and 408.2. Thus, the screws 410 can act on the laser 16 to displace the laser 16 against the bias of the spring 408 in order to calibrate the laser 16 by making positional adjustments to the laser 16.

The hub 402 defines a lens socket 412 at a front end 414 of the hub 402. The substructure 404 extends into the lens socket 412 and has a front opening 416 to allow emission or establishment of the laser beam 28.

A lens holder 418 is mounted in the lens socket 412. A lens 422 is mounted in the lens holder 418 so that, when the lens holder 418 is mounted in the lens socket 412, the lens 422 is aligned with the front opening 416 so that the laser beam 28 can be emitted through the lens 422. The lens holder 418 includes a support member or support plate 424 that defines an opening in which the lens 422 is supported.

A mounting formation 425 depends from the plate 424 to engage the substructure 404 to retain the lens holder 418 in position.

Control circuitry for controlling operation of the laser 16 is mounted in the hub 410. The control circuitry can be in the form of a Controller or Control Printed Circuit Board (PCB) 426 mounted in the hub 402. A power button 428 is mounted in the plate 424. The power button 428 is connected to the PCB 426 via an elongate button spring 429 so that the laser 16 can be powered by operation of the power button 428.

A battery housing 434 is mounted in the hub 402 so that the PCB 426 is interposed between the battery housing 434 and the substructure 404. An electrical connector arrangement 436 extends from the housing 434 to be in contact with the laser 16 via the substructure 404.

A back cover 438 is releasably engageable with the hub 402 to close the hub 402 to secure the various components within the hub 402 and also to allow replacement of the components within the hub 402, if necessary.

A wall 439 of the hub 402 and the back cover 438 have complementary formations to allow releasable attachment of the cover 438 to the hub 402. In this example, the bottom cover has projections 440 and the hub has partially circumferential slots 442 so that the cover 438 can be fitted, bayonet-fashion, to the hub 402.

The device 400 includes a number of interchangeable gripping arrangements 444. Thus, the device 400 can be supplied with different sets of gripping arrangements 444 to accommodate differently sized pipes or fittings.

Each gripping arrangement 444 includes a base 446. The base 446 and the wall 439 have complementary engagement formations so that the base 446 can be releasably engaged with the hub 402. In this embodiment, the hub wall 439 defines elongate recesses 448 that correspond with the respective bases 446. A peripheral wall 450 of each recess 448 defines an overhanging lip 452. The base 46 defines a ridge 454 that can be secured under the ridge 454 to retain the gripping arrangement 444 in position. For example, the base 46 can, via the ridge 454 and the lip 452, be slid in and out of the recess 448 for replacement of the gripping arrangement 444.

The base 46 is elongate and generally rectangular. The base 446 defines an inner wall 458.1.

An arm 456 extends from the base 446. Two tabs 462.1 and 462.2 extend from the arm 456 and are spaced with respect to each other and the base 46. The tabs 462.1 also overhang the inner wall 458 defined by the base 446.

The tab 462.1 defines an inner wall 458.2 that, together with the inner wall 458.1 defines a gap 464.1. The tab 462.1 also defines an inner wall 458.3. The tab 462.2 defines an inner wall 458.4 that, together with the inner wall 458.2 defines a gap 464.2. The tab 462.2 defines an outer wall 466.

The gripping arrangements 444 and the hub 402 are configured so that the inner walls 458.1 and 458.3 and the outer wall 466 can correspond with respective internal surfaces of pipes or fittings that can be engaged by those walls 458 and 464 when the gripping arrangements 444 are mounted on the hub 402, as described above. Thus, the gripping arrangements 444 and the hub 402 are configured so that, when the gripping arrangements 444 are mounted on the hub 402, the inner walls 458.1 and 458.3 and the outer wall 464 lie on respective concentric circles with reference to the rotational axis 460.

As mentioned above, the gripping arrangements 444 can be those of one set of gripping arrangements 444 that are configured to allow the device 400 to be mounted on a set of three differently sized pipes or fittings. It is envisaged that the device 400 can be provided with further sets of gripping arrangements 444 that are configured to allow the hub 400 to be mounted on differently sized sets of pipes or fittings. It is also envisaged that the sets of gripping arrangements 444 can be supplied separately to the device 400.

The back cover 438 has a collar 466 from which the projections 440 extend, inwardly. The collar 466 is dimensioned so that when the back cover 438 is connected to the hub 402, the collar 466 bears against the bases 446 to retain the gripping arrangements 444 in position. Thus, when the collar 466 is removed, the bases 446 can slide out of the respective recesses 448 in order to replace the gripping arrangements 444. It follows that the collar 466 serves as a retaining mechanism arranged on the hub wall 439 to retain the bases in the respective recesses, in a releasable manner.

In one example, the laser guide device 10, 400 can be configured so that the laser 16 can be removed and replaced. It follows that the inventor envisages that the device 10, 400 can be provided with or without the laser. Thus, various exemplary embodiments of the laser guide device have the mounting system configured for removable engagement or arrangement with respect to the laser. Also, various exemplary embodiments of the laser guide device include the devices described above, without the laser 16.

Throughout the specification, the use of common reference numerals is intended to refer to common components. However, this is for the purposes of convenience only and such use of common reference numerals is not intended to limit the scope of the appended claims.

Throughout the specification, including the claims, where the context permits, the term “comprising” and variants thereof such as “comprise” or “comprises” are to be interpreted as including the stated integer or integers without necessarily excluding any other integers.

It is to be understood that the terminology employed above is for the purpose of description and should not be regarded as limiting. The described embodiments are intended to be illustrative of the invention, without limiting the scope thereof. The invention is capable of being practised with various modifications and additions as will readily occur to those skilled in the art.

Various substantially and specifically practical and useful exemplary embodiments of the claimed subject matter, are described herein, textually and/or graphically, including the best mode, if any, known to the inventors for carrying out the claimed subject matter. Variations (e.g., modifications and/or enhancements) of one or more embodiments described herein might become apparent to those of ordinary skill in the art upon reading this application. The inventors expect skilled artisans to employ such variations as appropriate, and the inventors intend for the claimed subject matter to be practiced other than as specifically described herein. Accordingly, as permitted by law, the claimed subject matter includes and covers all equivalents of the claimed subject matter and all improvements to the claimed subject matter. Moreover, every combination of the above described elements, activities, and all possible variations thereof are encompassed by the claimed subject matter unless otherwise clearly indicated herein, clearly and specifically disclaimed, or otherwise clearly contradicted by context.

The use of any and all examples, or exemplary language (e.g., “such as”) provided herein, is intended merely to better illuminate one or more embodiments and does not pose a limitation on the scope of any claimed subject matter unless otherwise stated. No language in the specification should be construed as indicating any non-claimed subject matter as essential to the practice of the claimed subject matter.

Thus, regardless of the content of any portion (e.g., title, field, background, summary, description, abstract, drawing figure, etc.) of this application, unless clearly specified to the contrary, such as via explicit definition, assertion, or argument, or clearly contradicted by context, with respect to any claim, whether of this application and/or any claim of any application claiming priority hereto, and whether originally presented or otherwise:

a. there is no requirement for the inclusion of any particular described or illustrated characteristic, function, activity, or element, any particular sequence of activities, or any particular interrelationship of elements;

b. no characteristic, function, activity, or element is “essential”;

c. any elements can be integrated, segregated, and/or duplicated;

d. any activity can be repeated, any activity can be performed by multiple entities, and/or any activity can be performed in multiple jurisdictions; and

e. any activity or element can be specifically excluded, the sequence of activities can vary, and/or the interrelationship of elements can vary.

The use of the terms “a”, “an”, “said”, “the”, and/or similar referents in the context of describing various embodiments (especially in the context of the following claims) are to be construed to cover both the singular and the plural, unless otherwise indicated herein or clearly contradicted by context. The terms “comprising,” “having,” “including,” and “containing” are to be construed as open- ended terms (i.e., meaning “including, but not limited to,”) unless otherwise noted.

Moreover, when any number or range is described herein, unless clearly stated otherwise, that number or range is approximate. Recitation of ranges of values herein are merely intended to serve as a shorthand method of referring individually to each separate value falling within the range, unless otherwise indicated herein, and each separate value and each separate subrange defined by such separate values is incorporated into the specification as if it were individually recited herein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

Words indicating direction or orientation, such as “front”, “rear”, “back”, etc, are used for convenience. For example, words such as “front” or “forward” indicate a direction of emission of the laser beam 28. Words such as “rear” or “back” have an opposite meaning or connotation. The inventor(s) envisages that various embodiments can be used in a non-operative configuration, such as when presented for sale. Thus, such words are to be regarded as illustrative in nature, and not as restrictive.

Accordingly, every portion (e.g., title, field, background, summary, description, abstract, drawing figure, etc.) of this application, other than the claims themselves, is to be regarded as illustrative in nature, and not as restrictive, and the scope of subject matter protected by any patent that issues based on this application is defined only by the claims of that patent.

1-16. (canceled)

17. A laser guide device comprising:
at least one laser having a configuration capable of emitting a laser beam along a guide axis; and
a mounting system operatively arranged with respect to said laser and configured for mounting said laser centrally within or adjacent a cylindrical mouth opening of an object, said mounting system including at least one grip arrangement configured for mounting said laser guide device on a rim defining the cylindrical mouth opening, said grip arrangement defining at least one grip formation having a configuration capable of bearing against one of a radially outer and a radially inner surface at the mouth opening.

18. The laser guide device according to claim 17, wherein said grip formation defines a gap in which the rim of the cylindrical mouth opening is receivable.

19. The laser guide device according to claim 18, wherein said mounting system includes a carrier for carrying said laser, said grip arrangement is arranged on said carrier and said grip formation includes at least two facing, internal gap walls that are spaced apart to define said gap.

20. The laser guide device according to claim 19, wherein said internal gap walls each have concentric arcuate profiles relative to the guide axis.

21. The laser guide device according to claim 17, wherein said grip arrangement is at least two grip arrangements associated with said internal gap walls of said grip formation being circumferentially aligned so that each of said gap occupies a circular or annular path about the guide axis.

22. The laser guide device according to claim 21, wherein each of said grip arrangement includes at least two grip formations that are radially spaced relative to the guide axis.

23. The laser guide device according to claim 22, wherein each of said grip arrangement is detachable from said carrier to be replaced with further grip arrangements having different configurations to correspond with a cylindrical mouth opening of differently sized objects.

24. The laser guide device according to claim 19, wherein said carrier includes a hub having a configuration capable of housing said laser and said grip arrangement, said hub includes an arm that extends radially, with respect to the guide axis, from said hub, said grip formation being spaced along said arm.

25. The laser guide device according to claim 24, wherein said grip arrangement includes a base with each of said arm extending from said base, respectively.

26. The laser guide device according to claim 25, wherein said hub includes a wall of the hub, and said base defines complementary releasable engaging formations so that said base is removably mounted on said hub for replacement.

27. The laser guide device according to claim 26, wherein said wall of said hub defines a recess, said recess and said base being configured so that said base slides into and out of said recess.

28. The laser guide device according to claim 27 further comprises a retaining mechanism having a configuration capable of being arranged on said hub wall to retain, in a releasable manner, said base in said recess.

29. The laser guide device according to claim 17 further comprises an adaptor including a body and arms radiating from said body, said body having a configuration capable of receiving said laser and at least a part of said mounting system, said arms each include at least one circumferential tab capable mounting said adaptor within or adjacent the cylindrical mouth opening of the object.

30. The laser guide device according to claim 29, wherein said tab extends forwardly with respect to said arms, respectively, said tab each includes an outer wall configured to engage an inner surface of the cylindrical mouth opening of the object.

31. The laser guide device according to claim 30, wherein said arms each define a window configured for receiving therethrough at least one of said grip arrangement of said mounting system.

32. The laser guide device according to claim 30, wherein said body defines at least one hole having a configuration capable for pushing said laser or a hub containing said laser out of said body.

33. A laser guide device comprising:
a mounting system including at least one grip arrangement having a configuration capable of mounting said laser guide device on a rim that defines a cylindrical mouth opening of an object, said mounting system being configured for mounting at least one laser centrally within or adjacent the cylindrical mouth opening, said grip arrangement defining at least one grip formation having a configuration capable of bearing against one of an outer and an inner wall defining the mouth opening.

34. The laser guide device according to claim 33 further comprises a hub having a configuration capable of housing said laser, with said grip arrangement is associated with said hub or is configured to receive said hub.

35. A method of using a laser guide device for providing at least one laser with an object, said method comprising the steps of:
positioning at least one grip arrangement associated with said laser guide device within or adjacent a cylindrical mouth opening of the object;
arranging a mounting system with respect to at least one laser and configuring said mounting system for positioning said laser centrally within or adjacent the cylindrical mouth opening;
mounting at least one grip arrangement of said mounting system on a rim defining the cylindrical mouth opening so that said laser guide device is mounted on the rim, said grip arrangement defining at least one grip formation capable of bearing against one of a radially outer and a radially inner surface defining the mouth opening; and
operating said laser to emit a laser beam along a guide axis.
